(19) United States
(12) Patent Application Publication
(10) Pub. No.: US 2017/0292536 A1
(43) Pub. Date: Oct. 12, 2017

(54) RETURN STAGE OF A MULTI-STAGE TURBOCOMPRESSOR OR TURBOEXPANDER HAVING ROUGH WALL SURFACES

(71) Applicant: Siemens Aktiengesellschaft, Munich (DE)

(72) Inventor: Sven König, Trier (DE)

(73) Assignee: Siemens Aktiengesellschaft, Munich (DE)

(21) Appl. No.: 15/512,766

(22) PCT Filed: Sep. 28, 2015
(86) PCT No.: PCT/EP2015/072208

§ 371 Date: Mar. 20, 2017

(30) Foreign Application Priority Data
Sep. 30, 2014 (DE) 102014219821.6

(51) Int. Cl. F04D 29/68; F04D 17/12; F04D 29/44; F01D 9/04

(52) U.S. Cl. CPC F04D 29/681; F01D 9/045; F04D 17/122; F04D 29/444; F05D 2220/40; F05D 2250/63; F05D 2300/516

(57) ABSTRACT

A return stage of a radial turbo fluid energy machine, in particular of a radial turbo compressor, having an axis of rotation, the return stage has an annular flow channel for feeding a flowing process fluid from a flow opening of a first impeller to a flow opening of a second impeller arranged downstream. In order to increase efficiency, the flow channel is defined by bounding surface areas, of which at least one certain rough area extending in the circumferential direction has a surface roughness that is increased in relation to the her areas.

### CROSS REFERENCE TO RELATED APPLICATIONS

This application is the US National Stage of International Application No. PCT/EP2015/072208 filed Sep. 28, 2015, and claims the benefit thereof. The International Application claims the benefit of German Application No. DE 102014219821.6 filed Sep. 30, 2014. All of the applications are incorporated by reference herein in their entirety.

### FIELD OF INVENTION

The invention relates to a return stage of a multi-stage turbocompressor having rough wall surfaces.

### BACKGROUND OF INVENTION

In the case of radial turbo fluid energy machines, in particular in the case of radial turbocompressors, process fluid is sucked axially from an impeller and discharged radially in accelerated form. In the case of a multi-stage design, what is termed a return stage performs the feed of the process fluid discharged from the impeller upstream to a further impeller located further downstream. In this respect, said return stage has the function not only of deflecting the process fluid from the flow direction radially outward into an axial flow direction and feeding it to the further impeller, but also of decelerating the flow of the process fluid at least in certain portions and of thereby increasing the pressure in accordance with Bernoulli. The return stage is in this respect simultaneously formed regularly as a diffuser in a radially outwardly directed flow path and also as a confuser in a radially inwardly directed flow path when the process fluid is being fed to the further impeller. The return stage is stationary in relation to the impellers and guide blades provided in the return stage regularly alter the swirl and therefore the direction of flow of the process fluid in preparation for the subsequent entry into the downstream compression. This demanding aerodynamic task of the return stage requires a careful fluidic design for minimizing pressure losses and for optimizing efficiency. Nevertheless, pressure losses which are caused by friction and are accordingly unavoidable at the surfaces wetted by flow arise as the flow passes through radial diffusers and confusers of the return stage, said pressure losses reducing the efficiency of the turbomachine. In the case of given operating conditions with respect to gas type, pressure and temperature, the local pressure losses caused by friction are dependent on the local flow velocity and also the local roughness of the surface wetted by flow. In general, high pressure losses arise where the local flow velocities and at the same time the local roughnesses of the surfaces over which flow passes are high.

It is already known from EP 1 433 960 B1 to smooth the flow-guiding components by means of polishing to the effect that the overall efficiency of the compressor is increased. A uniform maximum roughness (e.g. RZ12) is usually required for the surfaces wetted by flow in the radial diffuser or confuser, particularly when said surfaces are produced from one component or in one production process. This procedure, which is also proposed in EP 1 433 960 B1, involves an additional amount of work and leads to considerable additional costs.

### SUMMARY OF INVENTION

Proceeding from the described prior art, the invention has addressed the problem of designing the surface of the flow-guiding regions of the return stage in such a manner as to achieve, compared to the known solutions, a reduced or possibly unchanged production outlay combined with an improved efficiency of the turbocompressor.

To solve the problem according to the invention, what is proposed is a return stage of the type defined in the introduction having the additional features of the independent claim. The dependent claims which refer back thereto in each case contain advantageous developments of the invention.

Unless stated otherwise, terms such as axial, tangential, radial or circumferential direction always refer to an axis of rotation of the radial turbocompressor. The return stage according to the invention is a component extending annularly about the axis of rotation. Said component can be formed so as to be split or unsplit in the circumferential direction. Provision is advantageously made of a configuration split in the circumferential direction, so as to give rise to a split joint of the return stage or of the return stages which allows for the rotor to be separated without the rotor being disassembled in the case of a split return stage.

A configuration in which the return stage is unsplit in the circumferential direction is also conceivable in principle, particularly in the case of an axially disassemblable rotor.

Within the context of this invention, roughness always means—unless stated otherwise—the mean roughness depth Rz in [μm] in accordance with DIN EN ISO 4287:1998.

The return stage is generally formed in an axially split manner, wherein a blade base separates the radially outwardly guided branch of the flow channel from a radially inwardly guided branch downstream of the 180° deflection of the flow, and said blade base is mounted on an intermediate base of the return stage, wherein the intermediate base serves on the one hand for guiding the flow in the return stage and on the other hand for fastening the return stage to the other component parts of the turbocompressor, for example to an inner casing or to a support encompassing an inner bundle of the turbocompressor.

One advantageous development of the invention provides that the flow channel of the return stage can conceptually be broken down into the following portions.

A first portion extends radially and has a radial opening to an impeller arranged upstream at a first end of the first portion.

A second portion adjoins the second end of the first portion—arranged upstream in the case of the turbocompressor—with a first end of the second portion and the flow is deflected by approximately 180° from one radial direction into the opposing radial direction.

A third portion, which runs substantially radially, adjoins a second end—arranged upstream in the case of the turbocompressor—of the second portion with a first end.

A fourth portion radially adjoins a second end of the third portion—arranged upstream in the case of the turbocompressor—radially with a first end of the fourth portion. The fourth portion deflects the flow by approximately 90° in the axial direction and, with a second end of the fourth portion, it has an axial opening to the second impeller arranged downstream.

In these portions, it is advantageous according to the invention that the rough regions are provided at various positions, specified in detail hereinbelow.

A first rough region in the first portion is advantageously arranged on that axial boundary surface which is at a greater axial distance from the third portion than the other axial boundary surface.

A second rough region on the radially inner boundary surface of the second portion, beginning at the second end of the second portion, is advantageously arranged in a manner extending over between 30% and 70% of the extent along the flow channel.

A third rough region advantageously directly adjoins the second rough region in the third portion and is provided in a manner extending between 5% and 40% along the flow channel.

A fourth rough region is advantageously located in the fourth portion on the radially outer boundary surface.

A further development of the invention provides that the rough regions each extend over the entire extent of the flow channel.

If the radial turbo fluid energy machine is a turbocompressor, a process fluid flows through the portions in the sequence of first portion, second portion, third portion, fourth portion.

If the radial turbo fluid energy machine is a turbocompressor, a process fluid flows through the portions in the sequence of fourth portion, third portion, second portion, first portion.

The first portion of the flow channel may expediently have guide blades in order to align the flow with the conditions present downstream.

The rough regions expediently have a mean roughness of 20 μm<Rz, particularly advantageously of 30 μm<Rz.

The non-rough regions advantageously have a mean roughness of 20 μm>Rz, particularly advantageously of 10 μm>Rz.

In those cases where the local flow velocity cannot be expediently adapted to a given local surface roughness, in order to keep the pressure losses caused by friction as low as possible, the local surface roughness should conversely, according to the invention, be adapted to the local flow velocity. The region-specific roughness of the surface according to the invention provides that the surface wetted with flow is designed with a lower roughness in the region of high flow velocities than in the region of relatively low flow velocities.

One advantageous application of the invention provides that the return stage has a bladed radial diffuser or, in the case of the radial turbine, a bladed radial confuser.

Another advantageous application of the invention provides that the return stage has a bladeless radial diffuser or, in the case of the radial turbine, a bladeless radial confuser.

The velocity level in the radial diffuser or in the radial confuser is at its highest at the annular space inner diameter—i.e. at the impeller outer diameter—and decreases with an increasing radius—i.e. outward. At the same time, the surface of the annular space walls which is wetted with flow and is to be machined becomes greater with the radius. By virtue of the regional adaptation, according to the invention, of the roughness to the local flow velocity level of the surfaces wetted with flow in radial diffusers and confusers, the pressure losses caused by friction are reduced without necessarily increasing the production costs for the components. This is achieved in particular because the increased outlay of a lower roughness over a small area in the region of high flow velocities is confronted by a reduced outlay with a higher permissible roughness over a large area in the region of relatively low flow velocities.

### BRIEF DESCRIPTION OF THE DRAWINGS

Hereinbelow, the invention is described in more detail on the basis of a specific exemplary embodiment and with reference to a drawing, in which:

FIG. 1 shows a schematic illustration of a longitudinal section through a turbocompressor according to the invention.

### DETAILED DESCRIPTION OF INVENTION

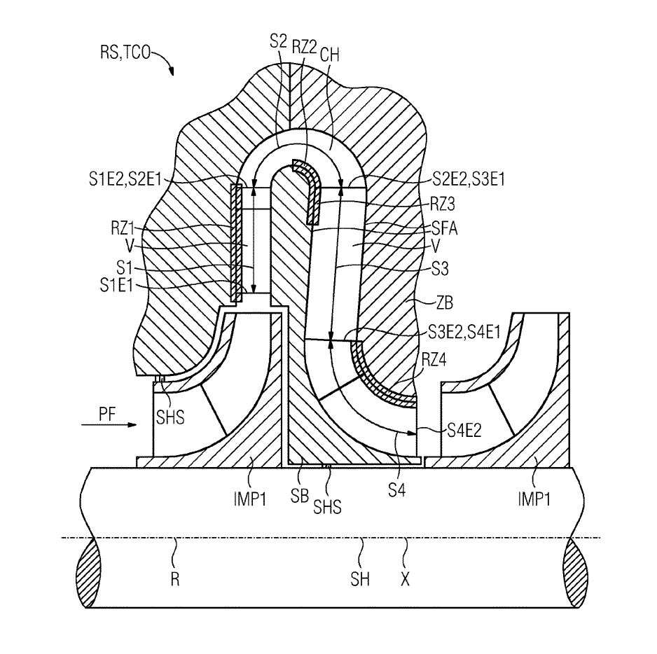

FIG. 1 shows a schematic longitudinal section through a return stage RS from a first impeller IMP1 to a second impeller IMP2 of a turbocompressor TCO.

The two impellers IMP1, IMP2 are component parts of a rotor R, the impellers IMP1, IMP2 being mounted in a force-fitting manner on a shaft SH extending along an axis X. The rotor R is surrounded by flow-guiding stationary components, of which here a return stage RS is shown. A multi-stage turbomachine generally comprises a plurality of return stages RS, which, as considered in the direction of flow from a first impeller IMP1, which, in the case of the turbocompressor TCO, axially sucks a process fluid PF and discharges it radially, deflect the process fluid PF by 180° following a radial diffuser section and guide it back radially inward and then deflect it in an axial direction, in order to feed the process fluid PF to the second impeller IMP2 located downstream.

The return stage generally comprises a blade base SB and an intermediate base ZB, which are fixedly connected to one another by means of guide blades V so as to form a flow channel between them. The return stages RS are generally configured in a manner split in the circumferential direction, such that a split of the return stage at a split joint makes it possible to remove the rotor from the structure of the return stages. The rotor is inserted radially during assembly or removed radially during disassembly.

The return stages RS have shaft seals SHS in relation to the rotor R at various locations, these shaft seals being intended to prevent the unused reduction of pressure differences or bypass flows during operation.

For the purposes of defining the invention, the flow channel CH extending from the first impeller IMP1 to the second impeller IMP2 is divided conceptually into four successive portions S1, S2, S3, S4, arranged in succession in the direction of flow in the case of the turbocompressor TCO. In the case of the turboexpander, the numbering of said portions S1-S4 is counter to the direction of flow. The first portion S1 extends substantially radially and has a radial opening to the first impeller IMP1 at a first end S1E1 of the first portion S1. The second portion S2 adjoins a second end S1E2 of the first portion S1 with a first end S2E1 of the second portion S2 and deflects the flow through the channel CH by approximately 180° from one radial direction into the opposing radial direction. In the case of the turbocompressor TCO, the flow is deflected from a direction in which it is directed radially outward into a direction radially inward. The third portion S3 adjoins the second portion S2 with a first end S3E1 of the third portion S3 adjoining the second end S2E2 of the second portion S2. Said portion runs substantially radially and, in the case of the turbocompressor TCO, guides the flow from radially further outward to radially further inward. The fourth portion radially adjoins a second end S3E2 of the third portion S3 radially with a first end S4E1 of the fourth portion S4 and deflects the flow by approximately 90° in the direction of the second impeller IMP2. A second end S4E2 of the fourth portion S4 adjoins the second impeller IMP2.

A first rough region RZ1 is located in the first portion S1 on that axial boundary surface which is at a greater axial distance from the third portion S3 than the other axial boundary surface.

A second rough region RZ2 is located on the radially inner boundary surface of the second portion S2, beginning at the second end S2E2 of the second portion S2. Said second rough region RZ2 extends over between 30%-70% of the extent along the flow channel of the second portion S2.

A third rough region RZ3 directly adjoins the second rough region RZ2 in the third portion S3 and extends over between 5%-40% along the flow channel CH in the third portion S3. A fourth rough region RZ4 extends in the fourth portion S4 on the radially outer boundary surface.

In principle, it is conceivable that not all of the four rough regions RZ1-RZ4 or only a single rough region are or is provided for improving the efficiency of the turbomachine TCO. The highest gain in efficiency is achieved by the complete implementation of the rough regions RZ1-RZ4 according to the invention and as per the exemplary embodiment shown in FIG. 1. In principle, it is conceivable that, of the boundary surfaces SFA of the flow channel CH, the rough regions RZ1-RZ3 are configured with extra roughness, or the other regions of the boundary surface SFA are provided with a lower surface roughness than the rough regions RZ1-RZ4, for example by means of polishing. In addition, it is also conceivable for provision to be made both of roughening of the rough regions RZ1-RZ4 and polishing of the other boundary surfaces SFA in order to achieve the effect according to the invention.

1. A return stage of a radial turbo fluid energy machine having an axis of rotation, the return stage comprising:
an annular flow channel for feeding a flowing process fluid from a flow opening of a first impeller to a flow opening of a second impeller arranged downstream,
wherein the flow channel is defined by boundary surface regions, of which at least one specific rough region extending in the circumferential direction has a surface roughness Rz which is increased with respect to other regions.

2. The return stage as claimed in claim 1,
wherein the flow channel has a first portion, which extends radially and has a radial opening to an impeller at a first end of the first portion.

3. The return stage as claimed in claim 2,
wherein the flow channel has a second portion, which adjoins a second end of the first portion with a first end of the second portion and deflects the flow by approximately 180° from one radial direction into the opposing radial direction.

4. The return stage as claimed in claim 3,
wherein the flow channel has a third portion, which runs substantially radially and adjoins a second end of the second portion with a first end of the third portion.

5. The return stage as claimed in claim 4,
wherein the flow channel has a fourth portion, which radially adjoins a second end of the third portion radially with a first end of the fourth portion and deflects the flow by approximately 90° and, with a second end of the fourth portion, has an axial opening to the second impeller.

6. The return stage as claimed in claim 4,
wherein a first rough region in the first portion is arranged on that axial boundary surface which is at a greater axial distance from the third portion than the other axial boundary surface.

7. The return stage as claimed in claim 6,
wherein a second rough region on the radially inner boundary surface of the second portion, beginning at the second end of the second portion, is located in a manner extending over between 30% and 70% of the extent along the flow channel.

8. The return stage as claimed in claim 7,
wherein a third rough region directly adjoins the second rough region in the third portion and is located in a manner extending between 5% and 40% along the flow channel.

9. The return stage as claimed in claim 8,
wherein a fourth rough region is located in the fourth portion on the radially outer boundary surface.

10. The return stage as claimed in claim 8,
wherein the rough regions each extend over the entire extent of the flow channel.

11. The return stage as claimed in claim 5,
wherein the fluid energy machine is a turbocompressor and a process fluid flows through the portions in the sequence of first portion, second portion, third portion, fourth portion.

12. The return stage as claimed in claim 5,
wherein the fluid energy machine is a turboexpander and a process fluid flows through the portions in the sequence of fourth portion, third portion, second portion, first portion.

13. The return stage as claimed claim 2,
wherein the first portion of the flow channel has guide blades.

14. The return stage as claimed in claim 8,
wherein the rough regions have a mean roughness of 20 μm<Rz.

15. The return stage as claimed in claim 1,
wherein non-rough regions have a mean roughness of Rz<20 μm.

16. The return stage as claimed in claim 1,
wherein the radial turbo fluid energy machine is a radial turbocompressor.
